(19) United States
(12) Patent Application Publication
(10) Pub. No.: US 2025/0355176 A1
(43) Pub. Date: Nov. 20, 2025

(54) OPTICAL DEVICE AND METHOD OF MANUFACTURE

(71) Applicant: Taiwan Semiconductor Manufacturing Co., Ltd., Hsinchu (TW)

(72) Inventors: Chia-Ning Weng, Taichung City (TW); Yu-Ming Chou, Hsinchu (TW); Shih Wei Liang, Taichung City (TW); Nien-Fang Wu, Chiayi City (TW); Jiun Yi Wu, Zhongli City (TW); Chen-Hua Yu, Hsinchu (TW)

(21) Appl. No.: 19/283,950

(22) Filed: Jul. 29, 2025

Related U.S. Application Data
(63) Continuation of application No. 18/401,851, filed on Jan. 2, 2024.
(60) Provisional application No. 63/509,094, filed on Jun. 20, 2023.
(60) Provisional application No. 63/519,361, filed on Aug. 14, 2023.
(60) Provisional application No. 63/607,822, filed on Dec. 8, 2023.

(51) Int. Cl. G02B 6/122; G02B 6/12; G02B 6/136

(52) U.S. Cl. CPC G02B 6/122; G02B 6/136; G02B 2006/12104

(57) ABSTRACT

Optical devices and methods of manufacture are presented herein. In an embodiment, an optical device is provided that includes a first substrate, the first substrate including an optical device layer, and a semiconductor die, a first waveguide structure over the first substrate, the first waveguide structure including a first optical component surrounded by cladding material, wherein the first waveguide structure has a top surface, the top surface including a first portion at a first distance from the first substrate, a second portion at a second distance from the first substrate, and a transition portion between the first portion to the second portion, wherein the second distance is greater than the first distance, and a first reflective structure over the first portion and the transition portion, wherein a portion of the first reflective structure over the transition portion is a curved surface.

### PRIORITY CLAIM

This application is a continuation of U.S. patent Ser. No. 18/401,851, filed on Jan. 2, 2024, which claims the benefit of U.S. Provisional Application No. 63/607,822, filed on Dec. 8, 2023, of U.S. Provisional Application No. 63/519,361, filed on Aug. 14, 2023 and of U.S. Provisional Application No. 63/509,094, filed on Jun. 20, 2023, each application is hereby incorporated by reference.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices, and improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate a formation of an optical device with embedded reflective structures for redirecting optical signals within the optical device, in accordance with some embodiments.

FIG. 10 illustrates a redirection interaction between an optical signal and the reflective structure, in accordance with some embodiments.

FIG. 11 illustrates an implementation of forming reflective structures in waveguide layers and a vertical transfer of the optical signal between the waveguide layers utilizing the reflective structures, in accordance with some embodiments.

FIG. 12 illustrates a utilization of an optical sensor to capture optical signals redirected by the embedded reflective structure, in accordance with some embodiments.

FIGS. 13-15 illustrate a formation and utilization of a reflective structure with an outward curved profile, in accordance with some embodiments.

FIGS. 16-18 illustrates a formation and utilization of a reflective structure with an inward curved profile, in accordance with some embodiments.

FIG. 19 illustrates an implementation of reflecting optical signals between waveguides with reflective structures of various profile shapes, in accordance with some embodiments.

FIGS. 20-22 illustrate various implementation of reflective structures that reflect portions of the optical signal and permit other portions of the optical signal to pass through the reflective structures, in accordance with various embodiments.

FIG. 23 illustrates a utilization of the reflective structures reflected between waveguides as well as permitted to pass through the reflective structures to interact with optical sensors, in accordance with some embodiments.

FIG. 24 illustrates a formation of a waveguide layer formed over a reflective structure allowing for bidirectional transfer of the optical signal, in accordance with some embodiments.

FIG. 25 illustrates a formation of a waveguide component positioned directly beneath the reflective structure, in accordance with some embodiments.

FIG. 26 illustrates a formation of multiple waveguide components providing individual optical signals to be reflected by the reflective structure, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a reflective surface, either a mirror or a distributed Bragg reflector is formed within an optical component layer. The reflective surface having different shapes and different reflective properties allowing for the control and directing of optical signals within one or more optical devices. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

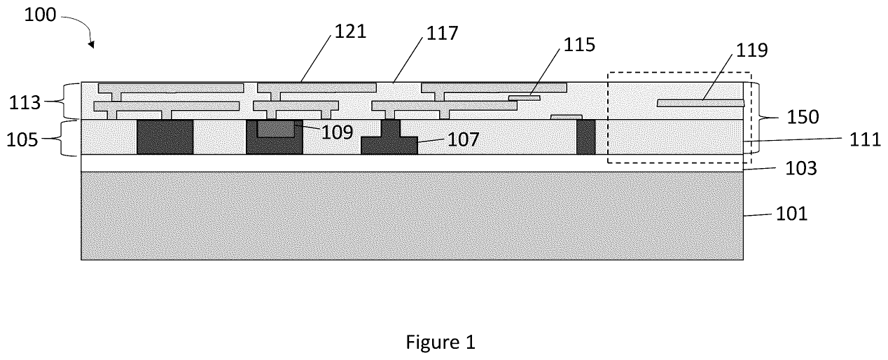

With reference now to FIG. 1, there is illustrated a first optical chiplet 100 in accordance with some embodiments. In the particular embodiment illustrated in FIG. 1, the first optical chiplet 100 is a photonic integrated circuit (PIC) and comprises at a beginning of the process a first substrate 101, a first insulating layer 103, and a layer of material for a first active layer 105 of first optical components 107. In an embodiment, at a beginning of the manufacturing process of the first optical chiplet 100, the first substrate 101, the first insulating layer 103, and the layer of material for the first active layer 105 of first optical components 107 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulating layer 103 may be a dielectric layer that separates the first substrate 101 from the overlying first active layer 105 and can additionally, in some embodiments, serve as a portion of cladding material that surrounds the subsequently manufactured first optical components 107 (discussed further below). In an embodiment the first insulating layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material for the first active layer 105 is initially (prior to patterning) a conformal layer of material that will be used to begin manufacturing the first active layer 105 of the first optical components 107. In an embodiment the material for the first active layer 105 may be a translucent material that can be used as a core material for the desired first optical components 107, such as a semiconductor material such as silicon, germanium, silicon germanium, combinations of these, or the like, while in other embodiments the material for the first active layer 105 may be a dielectric material such as silicon nitride or the like, although in other embodiments the material for the first active layer 105 may be III-V materials, lithium niobate materials, or polymers. In embodiments in which the material of the first active layer 105 is deposited, the material for the first active layer 105 may be deposited using a method such as epitaxial growth, chemical vapor deposition, atomic layer deposition, physical vapor deposition, combinations of these, or the like. In other embodiments in which the first insulating layer 103 is formed using an implantation method, the material of the first active layer 105 may initially be part of the first substrate 101 prior to the implantation process to form the first insulating layer 103. However, any suitable materials and methods of manufacture may be utilized to form the material of the first active layer 105.

FIG. 1 additionally illustrates that, once the material for the first active layer 105 is ready, the first optical components 107 for the first active layer 105 are manufactured using the material for the first active layer 105. In embodiments the first optical components 107 of the first active layer 105 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 107 may be used.

To begin forming the first active layer 105 of first optical components 107 from the initial material, the material for the first active layer 105 may be patterned into the desired shapes for the first active layer 105 of first optical components 107. In an embodiment the material for the first active layer 105 may be patterned using, e.g., one or more photolithographic masking and etching processes. However, any suitable method of patterning the material for the first active layer 105 may be utilized. For some of the first optical components 107, such as waveguides or edge couplers, the patterning process may be all or at least most of the manufacturing that is used to form these first optical components 107.

For those components that utilize further manufacturing processes, such as Mach-Zehnder silicon-photonic switches that utilize resistive heating elements, additional processing may be performed either before or after the patterning of the material for the first active layer 105. For example, implantation processes, additional deposition and patterning processes for different materials (e.g., resistive heating elements, III-V materials for converters), combinations of all of these processes, or the like, can be utilized to help further the manufacturing of the various desired first optical components 107. In a particular embodiment, and as specifically illustrated in FIG. 1, in some embodiments an epitaxial deposition of a semiconductor material 109 such as germanium (used, e.g., for electricity/optics signal modulation and transversion) may be performed on a patterned portion of the material of the first active layer 105. In such an embodiment the semiconductor material 109 may be epitaxially grown in order to help manufacture, e.g., a photodiode for an optical-to-electrical converter. All such manufacturing processes may be included and all suitable first optical components 107 may be manufactured, and all such combinations are fully intended to be included within the scope of the embodiments.

Once the individual first optical components 107 of the first active layer 105 have been formed, a second insulating layer 111 may be deposited to cover the first optical components 107 and provide additional cladding material. In an embodiment the second insulating layer 111 may be a dielectric layer that separates the individual components of the first active layer 105 from each other and from the overlying structures and can additionally serve as another portion of cladding material that surrounds the first optical components 107. In an embodiment the second insulating layer 111 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulating layer 111 has been deposited, the material may be planarized using, e.g., a chemical mechanical polishing process in order to either planarize a top surface of the second insulating layer 111 (in embodiments in which the second insulating layer 111 is intended to fully cover the first optical components 107) or else planarize the second insulating layer 111 with top surfaces of the first optical components 107. However, any suitable material and method of manufacture may be used.

Once the first optical components 107 of the first active layer 105 have been manufactured and the second insulating layer 111 has been formed, first metallization layers 113 are formed in order to electrically connect the first active layer 105 of first optical components 107 to control circuitry, to each other, and to subsequently attached devices. In an embodiment the first metallization layers 113 are formed of alternating first dielectric layers 117 and conductive material forming first metallization patterns 121. The alternating first dielectric layers 117 and the first metallization patterns 121 forming the first metallization layers 113 may be formed through any suitable processes (such as deposition, damascene, dual damascene, etc.). In particular embodiments, there may be multiple layers of the first metallization patterns 121 used to interconnect the various first optical components 107, but the precise number of first metallization layers 113 is dependent upon the design of the first optical chiplet 100.

Additionally, during the manufacture of the first metallization layers 113, one or more second optical components 115 may be formed as part of the first metallization layers 113. In some embodiments the second optical components 115 of the first metallization layers 113 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 115.

In an embodiment the one or more second optical components 115 may be formed by initially depositing a material for the one or more second optical components 115. In an embodiment the material for the one or more second optical components 115 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 115 has been deposited or otherwise formed, the material may be patterned into the desired shapes for the one or more second optical components 115. In an embodiment the material of the one or more second optical components 115 may be patterned using, e.g., one or more photolithographic masking and etching processes. However, any suitable method of patterning the material for the one or more second optical components 115 may be utilized.

For some of the one or more second optical components 115, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 115. For example, implantation processes, additional deposition and patterning processes for different materials, combinations of all of these processes, or the like, and can be utilized to help further the manufacturing of the various desired one or more second optical components 115. All such manufacturing processes may be included and all suitable one or more second optical components 115 may be manufactured, and all such combinations are fully intended to be included within the scope of the embodiments.

In a particular embodiment, the second optical components 115 may particularly comprise a first waveguide structure 119. In an embodiment, the first waveguide structure 119 is an edge coupler located adjacent to an edge of the first optical chiplet 100. In an embodiment the first waveguide structure 119 comprises multiple waveguides located at different levels of the first metallization layer 113, wherein the multiple waveguides collectively work together to receive light signals from outside of the first optical chiplet 100. However, any suitable combination of optical components may be utilized.

FIG. 1 further illustrates a first detail view 150. In an embodiment, the first detail view 150 depicts a portion of the first metallization layers 113 where the first metallization patterns 121 are not illustrated within the alternating first dielectric layers 117 for the purpose of clarity (but the first metallization patterns 121 may still be present). In this embodiment, the first detail view 150 depicts the first waveguide structure 119 embedded in a portion of the alternating first dielectric layers 117 over a portion of the second insulating layer 111 of the first active layer 105. Further, in this embodiment, the first optical components 107 of the first active layer 105 are not illustrated within the portion of the second insulating layer 111 depicted by the first detail view 150 for the purpose of clarity (but the first optical components 107 may still be present).

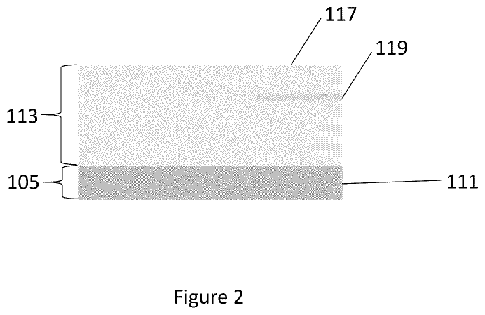

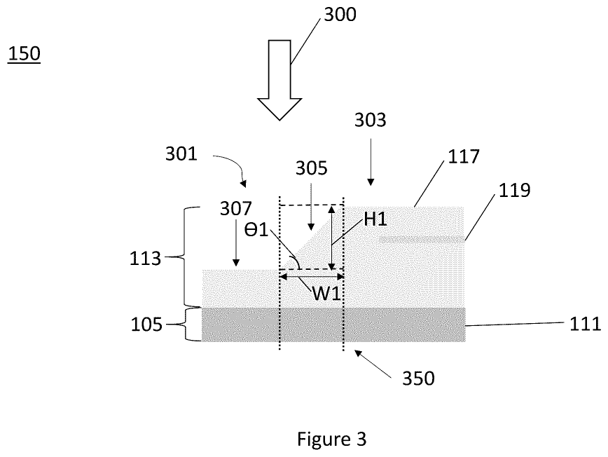

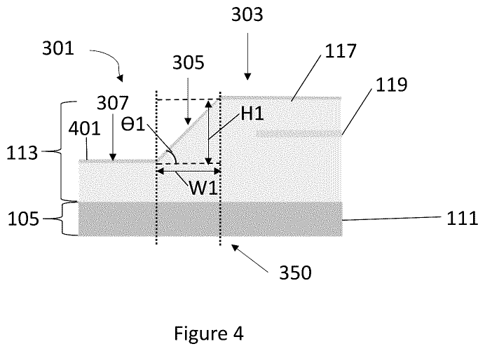

With reference now to FIG. 2, there is illustrated an isolated view of the first detail view 150 as initially depicted in FIG. 1. In an embodiment, the first detail view 150 illustrates the portion of the first metallization layers 113 comprising the first waveguide structure 119 embedded in the alternating first dielectric layers 117. The first detail view 150 further illustrates the portion of the first active layer 105 where the second insulating layer 111 may act as a work piece substrate for subsequent processes (e.g., a first patterning process 300, illustrated in FIG. 3) performed on the first metallization layers 113 to form a first reflective structure 401 (illustrated in FIG. 4) that may interface with the first waveguide structure 119.

With reference now to FIG. 3, the first patterning process 300 is performed on a first top surface 303 of the alternating first dielectric layers 117 to form a recess 301 within the first metallization layers 113. In an embodiment, the first patterning process 300 utilizes a first photoresist layer (not separately illustrated) over the first top surface 303. The first photoresist layer may be a single layer of a photosensitive material. The first photoresist layer may be formed over the first top surface 303 by depositing the photosensitive material by spin-on coating. However, any suitable deposition process or materials may be utilized for the first photoresist layer.

In an embodiment, the first photoresist layer may then be imaged using, for example, a first mask (not separately illustrated) to expose the first photoresist layer to an energy source forming a first pattern in the first photoresist layer. Following exposing the energy source to the first photoresist layer a developing step applied to the first photoresist layer may be applied. The developing step may involve applying a developer, such as tetramethylammonium hydroxide (TMAH) to the first photoresist layer utilizing such methods as spin-on coating to deliver the developer. However, any suitable developer and delivery method may be utilized. The developer physically removes the first pattern of the first photoresist layer exposed to the energy source forming an opening in the first photoresist layer.

In an embodiment, additional steps may be applied to the first photoresist layer such as, a post-exposure bake (PEB) performed on the first photoresist layer following the imaging step, and a hard-bake step applied to the first photoresist layer following the developing step. Any suitable number of applicable additional steps may be performed on the first photoresist layer.

In an embodiment, the first pattern may be passed onto the alternating first dielectric layers 117 forming the recess 301 by applying an etching process of the first patterning process 300 through the opening in the first photoresist layer and a removal of the first photoresist layer. In accordance with some embodiments, the recess 301 is formed by the etching process into the alternating first dielectric layers 117 on the first top surface 303 transferring the first pattern formed in the first photoresist mask to the first top surface 303 of the first metallization layers 113. The etching process may be one or more etching processes, such as a wet etch process, dry etch process, a reactive ion etching process, the like, or a combination thereof, that reacts with both the material of the alternating first dielectric layers 117 and the first photoresist layer.

In an embodiment, following the first patterning process 300, the recess 301 is formed within the alternating first dielectric layers 117 of the first active layer such that the alternating first dielectric layers 117 has a second top surface 307 at a bottom of the recess 301 and a transition top surface 305 between the first top surface 303 and the second top surface 307. A geometry of the recess 301 formed in the alternating first dielectric layers 117 defined by dimension lines 350, such that the transition top surface 305 has a first width W1 and a first height H1. In an embodiment, the first height H1 may be in a range of 5 μm to 20 μm. If the height of the transition top surface 305 is greater than the first height H1, than the recess 301 may extend too far into the alternating first dielectric layers 117 and interfere with active components within the first metallization layers 113. If the height of the transition top surface 305 has a height less than the first height H1, then a subsequently formed reflective surface (e.g., a first reflective structure 401) may not adequately align with the first waveguide structure 119. In an embodiment, the first width W1 may be in a range of 5 μm to 100 μm. If the width of the transition top surface 305 is outside the range of the first width W1 then an angle of the subsequently formed reflective surface may not adequately reflect optical signals within the first metallization layers 113. Further, in an embodiment, the transition top surface 305 having the first width W1 and the first height H1 forms a first angle θ1 between the second top surface 307 and the first top surface 303. In an embodiment, the first angle θ1 is in a range greater than 0° and less than 90°. If the transition top surface 305 has an angle between the second top surface 307 and the first top surface 303 outside the range of the first angle θ1 then the first optical signal 1000 that interfaces with the subsequently formed first reflective structure 401 over the transition top surface 305 may not be directed in a desired manner. However, any suitable dimensions may be utilized.

With reference now to FIG. 4, the first reflective structure 401 is formed in the recess 301 over the second top surface 307, and over the transition top surface 305, as well as over the first top surface 303. In an embodiment, the first reflective structure 401 may comprise a metal such as copper, titanium, titanium nitride, aluminum, aluminum nitride, gold, gold nitride, aluminum copper, or the like. The first reflective structure 401 may be deposited using processes such as sputtering, plating, evaporation, or plasma-enhanced chemical vapor deposition (PECVD), or the like, depending upon the desired materials. In an embodiment, the deposition process for forming the first reflective structure 401 forms the first reflective structure 401 to a conformal thickness over the first top surface 303, the transition top surface 305 and the second top surface 307. However, any suitable material or deposition process may be used in forming the first reflective structure 401.

In an alternative embodiment, prior to removing the first photoresist layer, and following the etching process of the first patterning process 300 that forms the recess 301 in the alternating first dielectric layers 117, the first reflective structure 401 may be formed within the recess 301 and over a top surface of the first photoresist layer in a similar manner and from similar materials as described above. In this embodiment portions of the first reflective structure 401 outside the recess 301 may be removed with the removal of the first photoresist layer.

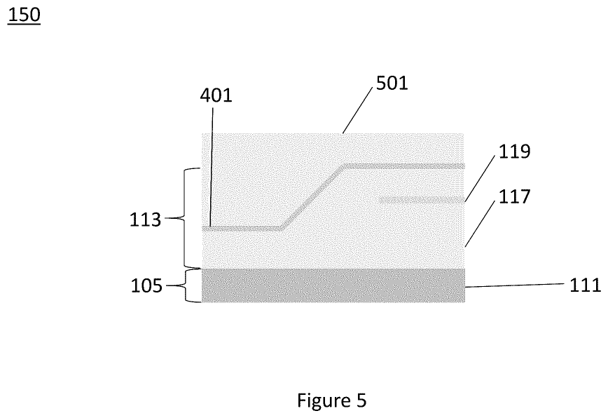

With reference now to FIG. 5, a second dielectric layer 501 is illustrated as formed over the first reflective structure 401. In an embodiment, the second dielectric layer 501 may be silicon oxide, silicon nitride, germanium oxide, germanium nitride, combinations of these, or the like. The second dielectric layer 501 may be formed using a deposition method such as CVD, ALD, PVD, combinations of these, or the like.

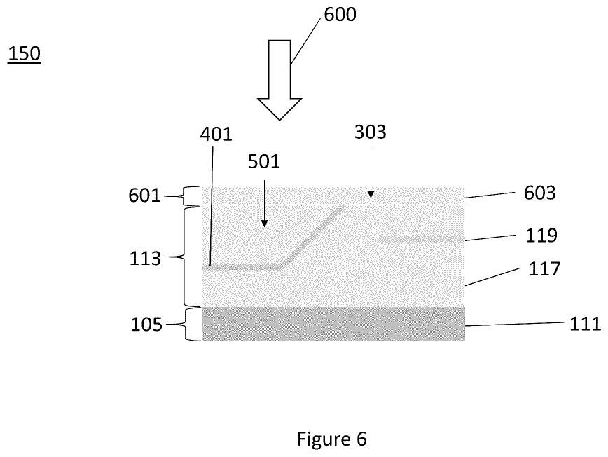

With reference now to FIG. 6, a first planarization process 600 is performed on the second dielectric layer 501 exposing the first top surface 303, followed by a formation of a first bond layer 601 over a remaining portion of the second dielectric layer 501 in the recess 301 and over the first top surface 303. In an embodiment, the first planarization process 600 removes excess material of the second dielectric layer 501 over the first top surface 303 and over the first metallization patterns 121. The first planarization process 600 may additionally remove portions of the first reflective structure 401 over the first top surface 303 outside the recess 301. In accordance with some embodiments, the first planarization process 600 may be a CMP process, a grinding process, combinations of these, or the like. However, any suitable planarization process may be utilized for the first planarization process 600.

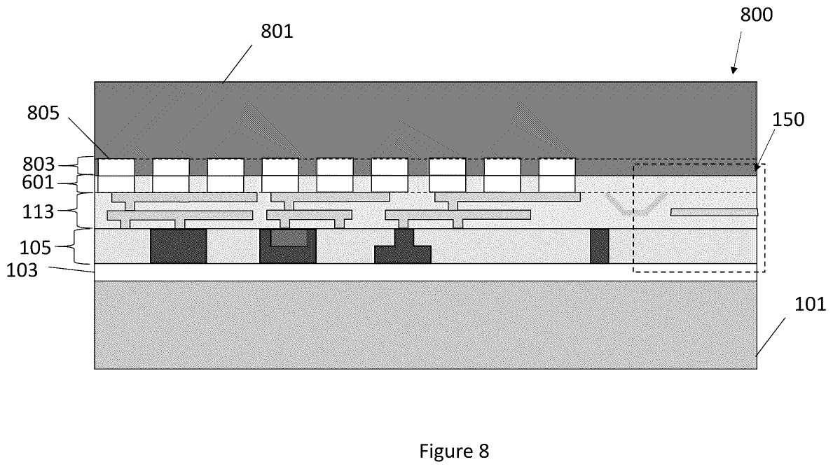

In an embodiment, following the first planarization process 600, the first bonding layer 601 may be formed over the remaining portion of the second dielectric layer 501 in the recess 301 and over the first top surface 303 of the alternating first dielectric layers 117. In an embodiment, the first bonding layer 601 may be used as part of a dielectric-to-dielectric and metal-to-metal bond to subsequently attached structures (not illustrated in FIG. 6 but illustrated and described further below with respect to FIG. 8). In accordance with some embodiments, the first bonding layer 601 is formed of a dielectric material 603 such as silicon oxide, silicon nitride, or the like. The dielectric material 603 may be deposited using any suitable method, such as CVD, high-density plasma chemical vapor deposition (HDPCVD), PVD, ALD, or the like. However, any suitable materials and deposition processes may be utilized for forming the dielectric material 603 of the first bonding layer 601.

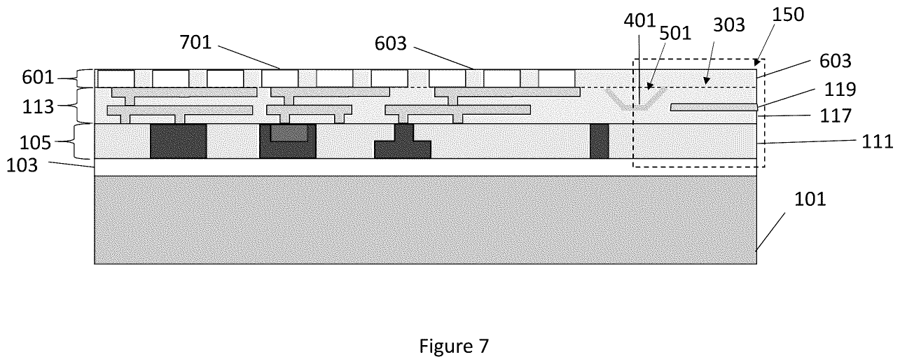

With reference now to FIG. 7, an expanded view of the first metallization layers 113 over the first active layer 105 outside the first detail view 150. In an embodiment, once the dielectric material 603 has been formed, openings (not separately illustrated) in the dielectric material 603 are formed to expose conductive portions of the underlying layers (e.g., the first metallization patterns 121) in preparation to form first bond pads 701 within the first bonding layer 601. Once the openings have been formed within the dielectric material 603, the openings may be filled with a seed layer (not separately illustrated) and a plated metal to form the first bond pads 701 within the dielectric material 603. The seed layer may be blanket deposited over top surfaces of the dielectric material 603 and the exposed conductive portions (e.g., the first metallization patterns 121) of the underlying layers and sidewalls of the openings. The seed layer may comprise a copper layer. The seed layer may be deposited using processes such as sputtering, evaporation, or plasma-enhanced chemical vapor deposition (PECVD), or the like, depending upon the desired materials. The plated metal may be deposited over the seed layer through a plating process such as electrical or electro-less plating. The plated metal may comprise copper, a copper alloy, or the like. The plated metal may be a fill material. A barrier layer (not separately illustrated) may be blanket deposited over top surfaces of the dielectric material 603 and sidewalls of the openings before filling the seed layer in the openings. The barrier layer may comprise titanium, titanium nitride, tantalum, tantalum nitride, or the like. Following the filling of the openings, a planarization process, such as a chemical mechanical polishing (CMP), is performed to remove excess portions of the seed layer and the plated metal, forming the first bond pads 701 within the first bonding layer 601.

With reference now to FIG. 8, a bonding of a semiconductor device 800 to the first metallization layers 113 through the first bonding layer 601 is illustrated. In some embodiments, the semiconductor device 800 is an electronic integrated circuit (EIC—e.g., devices without optical devices) and may have a semiconductor substrate 801, a layer of active devices (not separately illustrated), an overlying interconnect structure (not separately illustrated), a second bonding layer 803, and associated second bond pads 805. In an embodiment, the active devices may be transistors, capacitors, resistors, and the like formed over the semiconductor substrate 801, the interconnect structure may be similar to the first metallization layers 113, the second bonding layer 803 may be similar to the first bonding layer 601, and the second bond pads 805 may be similar to the first bond pads 701. However, any suitable devices may be utilized.

In an embodiment, the semiconductor device 800 may be configured to work with the first active layer 105 through the first metallization layers 113 for a desired functionality. In some embodiments the semiconductor device 800 may be an ASIC device, a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

Once the semiconductor device 800 has been prepared, the semiconductor device 800 may be bonded to the first bond layer 601. In an embodiment the semiconductor device 800 may be bonded to the first bond layer 601 using, e.g., a system on integrated circuit (SoIC) bond such as a dielectric-to-dielectric and metal-to-metal bonding process. In such an embodiment the semiconductor device 800 is bonded to the first bond layer 601 by bonding both the first bond pads 701 to the second bond pads 805 and by bonding the dielectrics within the first bonding layer 601 (e.g., the dielectric material 603) to the dielectrics within the second bonding layer 803. In this embodiment a surface of the semiconductor device 800 and the first bond layer 601 may first be activated utilizing, e.g., a dry treatment, a wet treatment, a plasma treatment, exposure to an inert gas, exposure to H2, exposure to N2, exposure to O2, or combinations thereof, as examples. In embodiments where a wet treatment is used, an RCA cleaning may be used, for example. However, any suitable activation process may be utilized.

After the activation process the semiconductor device 800 and the first bond layer 601 may be cleaned using, e.g., a chemical rinse, and then the semiconductor device 800 is aligned and placed into physical contact with the first bond layer 601. The semiconductor device 800 and the first bond layer 601 are then subjected to thermal treatment and contact pressure to bond the semiconductor device 800 and the first bond layer 601. For example, the semiconductor device 800 and the first bond layer 601 may be subjected to a pressure of about 200 kPa or less, and a temperature between about 25° C. and about 250° C. to fuse the semiconductor device 800 and the first bond layer 601. The semiconductor device 800 and the first bond layer 601 may then be subjected to a temperature at or above the eutectic point for material of the first bond pads 701 and the second bond pads 805, e.g., between about 150° C. and about 650° C., to fuse the first bond pads 701 and the second bond pads 805. In this manner, bonding of the semiconductor device 800 and the first bond layer 601 forms a bonded device. In some embodiments, the bonded semiconductor device 800 is baked, annealed, pressed, or otherwise treated to strengthen or finalize the bond.

Additionally, while the above description describes a dielectric-to-dielectric and metal-to-metal bonding process, this is intended to be illustrative and is not intended to be limiting. In yet other embodiments, the first metallization layers 113 may be bonded to the semiconductor device 800 by direct surface bonding, metal-to-metal bonding, or another bonding process. In other embodiments, the semiconductor device 800 and the first metallization layers 113 are bonded by metal-to-metal bonding that is achieved by fusing conductive elements. Any suitable bonding process may be utilized, and all such methods are fully intended to be included within the scope of the embodiments.

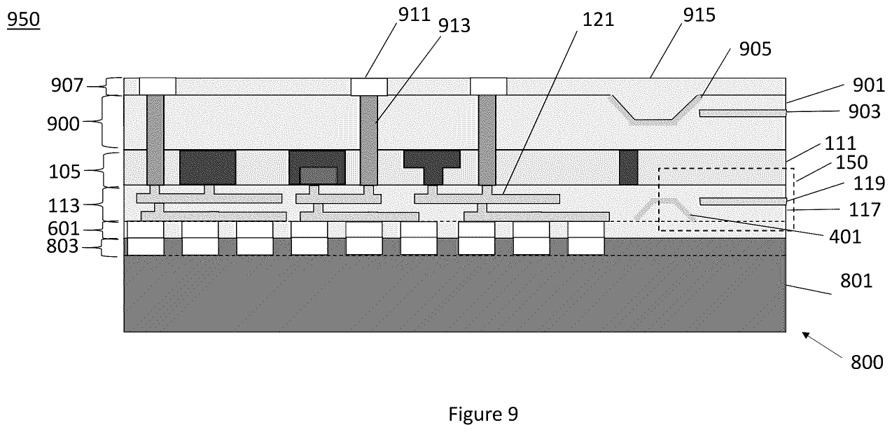

With reference now to FIG. 9, the semiconductor device 800 bonded to the first active layer 105 through the first metallization layers 113 is depicted flipped over. In an embodiment, after the semiconductor device 800 is bonded to the first metallization layers 113 a removal of the first substrate 101 and, optionally, the first insulating layer 103 is performed, thereby exposing a surface of the first active layer 105.

In an embodiment, following the removal of the first substrate 101 and the first insulating layer 103 an optical interconnect structure 900 may be formed on the exposed surface of the first active layer 105. The optical interconnect structure 900 may comprise of alternating third dielectric layers 901, second waveguide structure 903, and a second reflective structure 905. In an embodiment, the alternating third dielectric layers 901 may be formed in a similar manner and from similar materials as the alternating first dielectric layers 117. In an embodiment, the second waveguide structure 903 may be formed in a similar manner and from similar materials as the first waveguide structure 119. In an embodiment, the second reflective structure 905 may be formed in a similar manner and from similar materials as the first reflective structure 401. However, any suitable processes and materials may be utilized in forming the components of the optical interconnect structure 900.

Further, in an embodiment, once the optical interconnect structure 900 has been formed an interface layer 907 may be formed with conductive pads 911 and first through device vias (TDVs) 913. The interface layer 907 and the corresponding conductive pads 911 providing an interface for external connections. In an embodiment, the interface layer 907 may be a bond layer similar to the first bond layer 601 described above and the conductive pads 911 may be bond pads similar to the first bond pads 701 described above.

In an embodiment the first TDVs 913 extend through the optical interconnect structure 900 and the first active layer 105 so as to provide a quick passage of power, data, and ground through the first metallization layers 113. In an embodiment the first TDVs 913 may be formed by initially forming through device via openings (not separately illustrated) through the optical interconnect structure 900 and through the first active layer 105 to expose conductive portions of the first metallization patterns 121. The through device via openings may be formed by applying and developing a suitable photoresist (not separately illustrated), and removing portions of the alternating third dielectric layers 901 of the optical interconnect structure 900 and portions of the second insulating layer 111 of the first active layer 105.

Once the through device via openings have been formed through the optical interconnect structure 900 and through the first active layer 105, the through device via openings may be lined with a liner (not separately illustrated). The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition (PVD) or a thermal process, may alternatively be used.

Once the liner has been formed along sidewalls and a bottom of the through device via openings, a barrier layer (also not independently illustrated) may be formed and the remainder of the through device via openings may be filled with a first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used, resulting in the formation of the first TDVs 913. The first TDVs 913 in electrical connection with the first metallization patterns 121 of the first metallization layers 113.

In an embodiment, following the formation of the first TDVs 913, the interface layer 907 may be formed over the top surface of the optical interconnect structure 900. The interface layer 907 may be formed by first forming a fourth dielectric layer 915 over the second reflective structure 905 and over a top surface of the optical interconnect structure 900. In an embodiment, the fourth dielectric layer 915 may be silicon oxide, silicon nitride, germanium oxide, germanium nitride, combinations of these, or the like. The fourth dielectric layer 915 may be formed using a deposition method such as CVD, ALD, PVD, combinations of these, or the like. However, any suitable materials and processes may be utilized in forming the fourth dielectric layer 915.

In an embodiment, once the fourth dielectric layer 915 has been formed, openings (not separately illustrated) in the fourth dielectric layer 915 may be formed to expose conductive portions of the first TDVs 913 in preparation to form the conductive pads 911 within the interface layer 907. Once the openings have been formed within the fourth dielectric layer 915, the openings may be filled with a seed layer (not separately illustrated) and a plated metal to form the conductive pads 911 within the fourth dielectric layer 915. The seed layer may be blanket deposited over top surfaces of the fourth dielectric layer 915 and the exposed conductive portions of the first TDVs 913 and sidewalls of the openings. The seed layer may comprise a copper layer. The seed layer may be deposited using processes such as sputtering, evaporation, or plasma-enhanced chemical vapor deposition (PECVD), or the like, depending upon the desired materials. The plated metal may be deposited over the seed layer through a plating process such as electrical or electro-less plating. The plated metal may comprise copper, a copper alloy, or the like. The plated metal may be a fill material. A barrier layer (not separately illustrated) may be blanket deposited over top surfaces of the fourth dielectric layer 915 and the sidewalls of the openings before filling the seed layer in the openings. The barrier layer may comprise titanium, titanium nitride, tantalum, tantalum nitride, or the like. Following the filling of the openings, a planarization process, such as a chemical mechanical polishing (CMP), is performed to remove excess portions of the seed layer and the plate metal, forming the conductive pads 911 within the interface layer 907.

In an alternative embodiment, external connections may be made to the first metallization patterns 121 through the semiconductor device 800. In this embodiment through substrate vias (not separately illustrated) may be formed through the semiconductor substrate 801 of the semiconductor device 800 and may be electrically coupled to the interconnect structure of the semiconductor device 800. In this embodiment, an external connection structure (not separately illustrated) may then be formed on a backside of the semiconductor device 800 with external conductive connectors (not separately illustrated) electrically coupled to the through substrate vias.

In these embodiments, the resulting structure of the optical interconnect structure 900 formed over the first active layer 105 bonded to the semiconductor device 800 with structure providing for external electrical connections forms a first optical device 950.

In another alternative embodiment, the first active layer 105 is formed in a similar manner as described above and the first metallization layers 113 are formed in a similar manner as described above except the formation of the first reflective structure 401 may be omitted and the subsequent second dielectric layer 501 may be omitted. In this embodiment, the first metallization layers 113 is bonded to the semiconductor device 800 in a similar manner as described above, the first substrate 101 and the first insulating layer 103 are removed and the optical interconnect structure 900 may be formed over the first active layer 105 utilizing the semiconductor device 800 as a support substrate to facilitate the formation of the optical interconnect structure 900. In this embodiment, the resulting structure may also be referred to as the first optical device 950. Further, in this embodiment, the external electrical connections may be formed in a similar manner and from similar materials as described above within the first optical device 950.

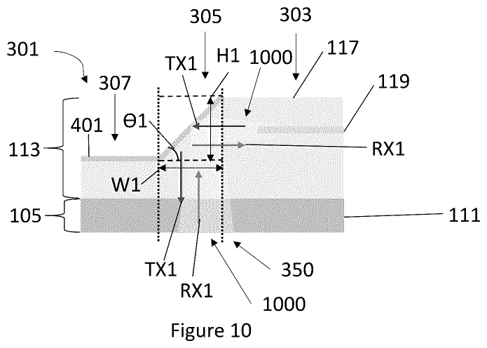

With reference now to FIG. 10, in the first detail view 150 a first optical signal 1000 is depicted interacting between the first waveguide structure 119 and the first reflective structure 401 and the first optical signal 1000 interacting between the first reflective structure 401 and the first active layer 105. The first optical signal 1000 may comprise a plurality optical signals at specific wavelengths being transferred in various directions. For example the first optical signal 1000 may comprise a first transmission signal TX1 provided by the first waveguide structure 119 at a first specific wavelength. The first optical signal 1000 may also comprise a first receiver signal RX1 provided by an optical component within the first active layer 105 at a second specific wavelength traveling in an opposite direction as the first transmission signal TX1 within the first optical signal 1000. The first transmission signal TX1 and the first receiver signal RX1 are merely illustrative and the first optical signal 1000 may comprise any number of suitable signals. In an embodiment, the first waveguide structure 119 is disposed within the alternating first dielectric layers 117 directly beneath the first top surface 303 such that the first optical signal 1000 passes through the alternating first dielectric layers 117 between the first top surface 303 and the transition top surface 305. In an embodiment, the first optical signal 1000 may transmit the first transmission signal TX1 from the first waveguide structure 119 towards the first reflective structure 401 over the transition top surface 305, the first transmission signal TX1 interfaces with the first reflective structure 401 over the transition top surface 305 at the first angle θ1. In an embodiment, after the first transmission signal TX1 of the first optical signal 1000 interacts with the first reflective structure 401 the first transmission signal TX1 is reflected towards active components within the first active layer 105. In another embodiment, the first optical signal 1000 may transmit the first receiver signal RX1 from active components within the first active layer 105 towards the first reflective structure 401 over the transition top surface 305, the first receiver signal RX1 interfaces with the first reflective structure 401 over the transition top surface 305 at the first angle θ1. In an embodiment, after the first receiver signal RX1 of the first optical signal 1000 interacts with the first reflective structure 401 the first receiver signal RX1 is reflected towards the first waveguide structure 119.

The interaction of the first optical signal 1000 depicted in the first detail view 150 as illustrated in FIG. 10 is merely illustrative and not intended to be limiting. In an embodiment, similar transfer of optical signals as described with respect to structures illustrated in the first detail view 150 depicted in FIG. 10 occurs between the first active layer 105 and the second reflective structure 905 with the second waveguide structure 903. For the sake of clarity, the first detail view 150 omits the depiction of the second dielectric layer 501.

Benefits of the presented embodiments include, but are not limited to, the ability to direct optical signals (e.g., the first optical signal 1000) within various optical devices (e.g., the first optical device 950) while allowing for finer control of directionality and shift in direction within such optical devices (e.g., the first optical device 950). By forming reflective structures (e.g., the first reflective structure 401) within waveguide layers (e.g., the optical interconnect structure 900) a vertical shift in direction of optical signals (e.g., the first optical signal 1000) may be more efficiently and more cost effectively performed.

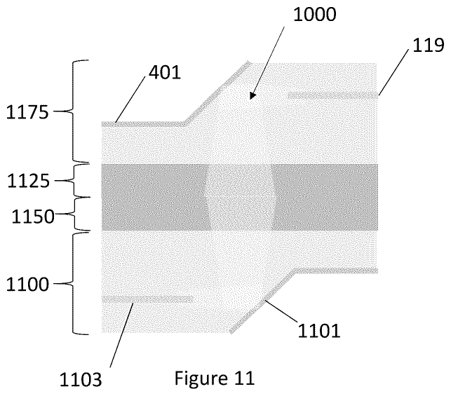

With reference now to FIG. 11, a first waveguide layer 1175 on a first waveguide substrate 1125 and a second waveguide layer 1100 on a second waveguide substrate 1150 are depicted where the first waveguide substrate 1125 is in physical contact with the second waveguide substrate 1150. In an embodiment, the first waveguide layer 1175 comprises the first reflective structure 401 and the first waveguide structure 119. The first waveguide layer 1175 may be formed in a similar manner and from similar materials as the first metallization layers 113 as discussed above and is formed on the first waveguide substrate 1125. In an embodiment, the first waveguide substrate 1125 may be a silicon substrate and may be formed of a bulk silicon. In an embodiment, the second waveguide layer 1100 comprises a third reflective structure 1101 and a third waveguide structure 1103. The second waveguide layer 1100 may be formed in a similar manner and from similar materials as the first metallization layers 113 as discussed above and is formed on the second waveguide substrate 1150. In an embodiment, the second waveguide substrate 1150 may be a silicon substrate and may be formed of a bulk silicon. In an embodiment, the third reflective structure 1101 is formed in a similar manner and from similar materials as the first reflective structure 401. In an embodiment, the third waveguide structure 1103 is formed in a similar manner and from similar materials as the first waveguide structure 119. However, any suitable method and materials may be utilized in forming the third reflective structure 1101 and the third waveguide structure 1103.

In an embodiment, the first optical signal 1000 may be provided by the first waveguide structure 119 where it is reflected by the first reflective structure 401 through the first waveguide layer 1175 through the first waveguide substrate 1125, the second waveguide substrate 1150, and the second waveguide layer 1100 where the first optical signal 1000 is reflected by the third reflective structure 1101 towards the third waveguide structure 1103 where it is received by the third waveguide structure 1103. In an embodiment, the first optical signal 1000 may be provided by the third waveguide structure 1103 where it is reflected by the third reflective structure 1101 through the second waveguide layer 1100 through the second waveguide substrate 1150, the first waveguide substrate 1125, and the first waveguide layer 1175 where the first optical signal 1000 is reflected by the first reflective structure 401 towards the first waveguide structure 119 where it is received by the first waveguide structure 119.

In an alternative embodiment, the first waveguide layer 1175 and the first waveguide substrate 1125 shares the structure of the first optical device 950, where the first waveguide layer 1175 is representative of the optical interconnect structure 900, and the first waveguide substrate is representative of the first active layer 105, the first metallization layers 113, and the semiconductor device 800. Further, in this embodiment, the first waveguide layer 1175 and the first waveguide substrate 1125 are bonded to a second optical device, the second optical device comprising the second waveguide layer 1100 and the second waveguide substrate 1150. In an embodiment, the second optical device is formed in a similar manner and from similar materials as the first optical device 950. In an embodiment, the semiconductor device 800 of the first optical device 950 may be bonded to the second waveguide substrate 1150 where the second waveguide substrate 1150 is a second semiconductor device of the second optical device through an oxide-to-oxide bond. In another embodiment, the semiconductor device 800 of the first optical device 950 may be bonded to the second semiconductor device of the second optical device through a dielectric-to-dielectric bond. In this embodiment, the semiconductor device 800 of the first optical device 950 may further be bonded to the second semiconductor device of the second optical device through metal-to-metal bonds which may additionally form electrical interconnections between the semiconductor device 800 and the second semiconductor device. In this embodiment, the first optical signal 1000 is transmitted in a similar manner as described above.

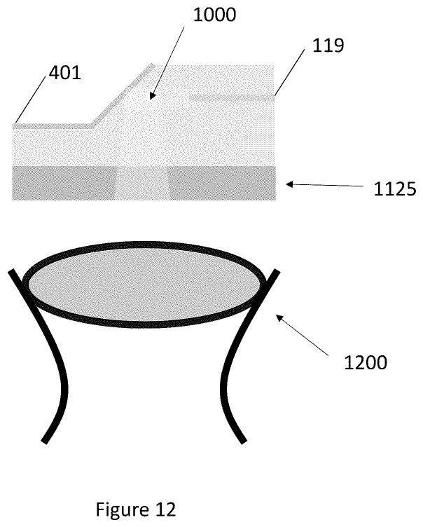

With reference now to FIG. 12, the first optical signal 1000 is depicted as transmitted from the first waveguide structure 119 towards the first reflective structure 401 where it is redirected towards the first waveguide substrate 1125. In this embodiment, at least a portion of the first optical signal 1000 passes through the first waveguide substrate 1125 where the first optical signal 1000 is captured by a first optical sensor 1200. In an embodiment, the first optical sensor 1200 may be a complimentary metal-oxide semiconductor (CMOS) sensor, a charge-coupled device (CCD), etc.

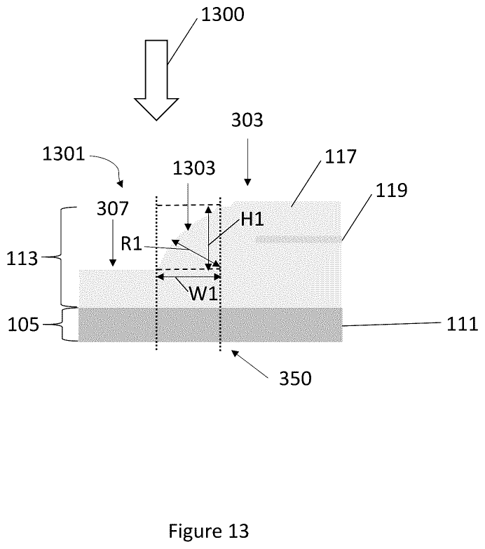

With reference now to FIG. 13, an embodiment is depicted in which the alternating first dielectric layers 117 as described above are patterned by a second patterning process 1300. In an embodiment, the second patterning process 1300 is performed on the first top surface 303 of the alternating first dielectric layers 117 to form a second recess 1301 within the first metallization layers 113. In an embodiment, the second patterning process 1300 utilizes a second photoresist layer (not separately illustrated) over the first top surface 303. The second photoresist layer may be a single layer of a photosensitive material. The second photoresist layer may be formed over the first top surface 303 by depositing the photosensitive material by spin-on coating. However, any suitable deposition process or materials may be utilized for the second photoresist layer. Further, in an embodiment, a second mask (not separately illustrated) may be utilized in the second patterning process 1300 to form a second pattern in the alternating first dielectric layers 117. The second mask may have transparency regions where radiation from a radiating source (not separately illustrated) is able to pass through the second mask during the second patterning process 1300. In an embodiment, the transparency regions are partially transparent (e.g. the transparency regions are not completely transparent), the degree of transparency in the transparency regions determining an amount of the radiation transmissible through the transparency regions of the second mask during the second patterning process 1300. In some embodiments, a transparency gradient exists within the transparency regions, such that the transparency regions allows for varying amounts of the radiation to pass through the second mask to allow for the formation of various patterns in the second photoresist layer.

During the second patterning process 1300 the radiating source directs the radiation toward the second mask where portions of the radiation are able to pass through the transparency regions of the second mask forming a patterned energy source that corresponds to the various patterns to be formed in the second photoresist layer. In some embodiments, the radiating source is a light source such that the radiation and corresponding patterned energy source is light (e.g. ultra-violet (UV) light). The second photoresist layer is exposed to the patterned energy source during an imaging step of the second patterning process 1300. The imaging step of the second patterning process 1300 forming the second pattern in the second photoresist layer corresponding to the patterned energy source applied during the imaging step.

In accordance with some embodiments, a geometry of the second pattern is dependent upon the patterned energy source generated by the transparency gradient in the transparency regions of the second mask. By having the transparency regions of the second mask be partially transparent the amount of energy various portions of the second photoresist layer is exposed to may be controlled by adjusting the transparency gradient. By controlling the amount of energy the various portions of the second photoresist layer is exposed to the patterned energy source may penetrate into the second photoresist layer at various depths and as such, a desired geometry of the second pattern may be achieved. In an embodiment, the second pattern formed may facilitate a formation of an outward curved pattern. However any suitable shape may be formed within the second photoresist layer using the second mask to filter the radiation energy to form the patterned energy source to form the desired pattern.

Following exposing the patterned energy source to the second photoresist layer a developing step applied to the second photoresist layer may be applied. The developing step may involve applying a developer, such as tetramethylammonium hydroxide (TMAH) to the second photoresist layer utilizing such methods as spin-on coating to deliver the developer. However, any suitable developer and delivery method may be utilized. The developer physically removes the second pattern of the second photoresist layer exposed to the patterned energy source forming an opening in the second photoresist layer.

In an embodiment, additional steps may be applied to the second photoresist layer such as, a post-exposure bake (PEB) performed on the second photoresist layer following the imaging step, and a hard-bake step applied to the second photoresist layer following the developing step. Any suitable number of applicable additional steps may be performed on the second photoresist layer.

In an embodiment, the second pattern may be passed onto the alternating first dielectric layers 117 forming the second recess 1301 by applying an etching process of the second patterning process 1300 through the opening in the second photoresist layer and a removal of the second photoresist layer. In accordance with some embodiments, the second recess 1301 is formed by the etching process into the alternating first dielectric layers 117 on the first top surface 303 transferring the second pattern formed in the second photoresist layer to the first top surface 303 of the first metallization layers 113. The etching process may be one or more etching processes, such as a wet etch process, dry etch process, a reactive ion etching process, the like, or a combination thereof, that reacts with both the material of the alternating first dielectric layers 117 and the second photoresist layer.

In an embodiment, following the second patterning process 1300, the second recess 1301 is formed within the alternating first dielectric layers 117 of the first active layer such that the alternating first dielectric layers 117 has the second top surface 307 at a bottom of the second recess 1301 and a second transition top surface 1303 between the first top surface 303 and the second top surface 307. A geometry of the second recess 1301 formed in the alternating first dielectric layers 117 defined by dimension lines 350, such that the second transition top surface 1303 has the first width W1 and the first height H1. Further, in an embodiment, the second patterning process 1300 may form the second transition top surface having the outward curve shape with a first radius of curvature R1. The first radius of curvature R1 being in a range of 3 μm and 200 μm. In an embodiment, the outward curve shape may have a constant radius of curvature, for example the first radius of curvature R1. If the second transition top surface 1303 has a radius of curvature outside the range of the first radius of curvature R1 then the first optical signal 1000 that interfaces with the subsequently formed first reflective structure 401 over the second transition top surface 1303 may not be directed in a desired manner. However, any suitable dimensions may be utilized.

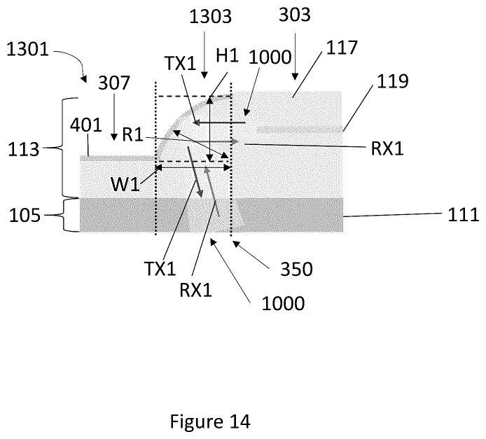

With reference now to FIG. 14, the first reflective structure 401 is formed over the second recess 1301, including over the second transition top surface 1303. In an embodiment, the first reflective structure 401 is formed in a similar process and from similar materials as described above. However, any suitable method and materials may be utilized in forming the first reflective structure 401 over the second transition top surface 1303.

In this embodiment, the first optical signal 1000 is reflected off the first reflective structure 401 at an acute angle. In an embodiment, the reflection direction of the first optical signal 1000 is influenced by the first radius of curvature R1. The resulting structure with the outward curved top surface for the second transition top surface 1303 may be referred to as a third optical device 1400.

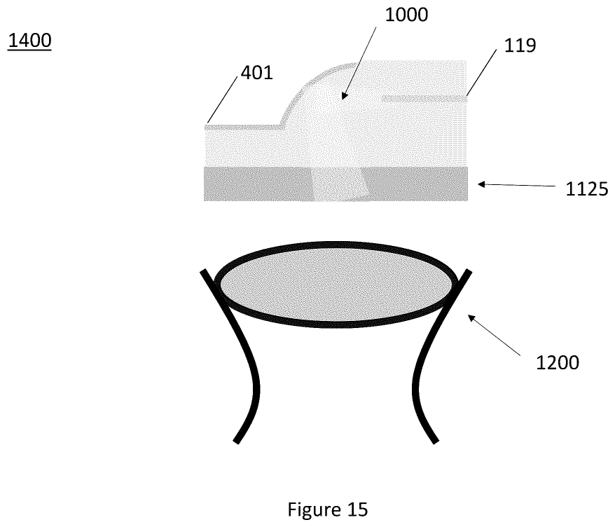

With reference now to FIG. 15, the first optical signal 1000 is depicted as transmitted from the first waveguide structure 119 within the third optical device 1400 towards the first reflective structure 401 where it is redirected towards the first waveguide substrate 1125. In this embodiment, at least a portion of the first optical signal 1000 passes through the first waveguide substrate 1125 where the first optical signal 1000 is captured by the first optical sensor 1200.

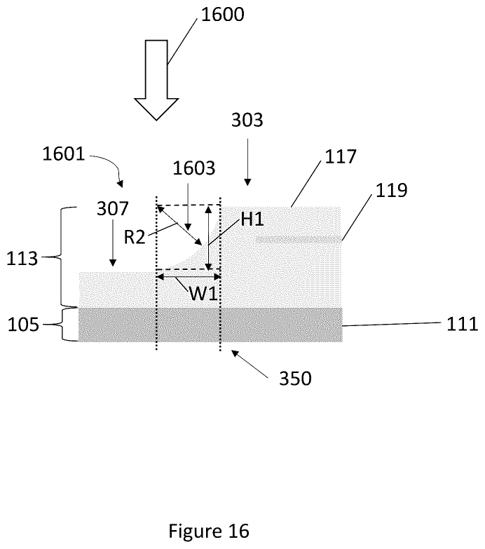

With reference now to FIG. 16, an embodiment is depicted in which the alternating first dielectric layers 117 as described above are patterned by a third patterning process 1600. In this embodiment, the third patterning process 1600 is similar to the second patterning process 1300 except the third patterning process 1600 forms a third pattern where the third patterning process 1600 forms a third recess 1601 with the first top surface 303, the second top surface 307, and a third transition top surface 1603. In this embodiment, the third transition top surface 1603 has an inward curved shape defined by the dimension lines 350 having the first width W1 and the first height H1. Further, in an embodiment, the third patterning process 1600 may form the third transition top surface 1603 having the inward curved shape with a second radius of curvature R2. The second radius of curvature R2 being in a range of 3 μm and 200 μm. In an embodiment, the inward curved shape may have a constant radius of curvature, for example the second radius of curvature R2. If the third transition top surface 1603 has a radius of curvature outside the range of the second radius of curvature R2 then the first optical signal 1000 that interfaces with the subsequently formed first reflective structure 401 over the third transition top surface 1603 may not be directed in a desired manner. However, any suitable dimensions may be utilized.

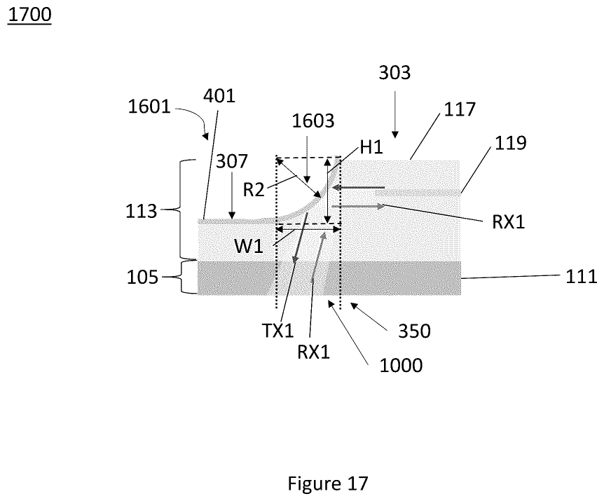

With reference now to FIG. 17, the first reflective structure 401 is formed over the third recess 1601, including over the third transition top surface 1603. In an embodiment, the first reflective structure 401 is formed in a similar process and from similar materials as described above.

In this embodiment, the first optical signal 1000 is reflected off the first reflective structure 401 at an obtuse angle. In an embodiment, the reflection direction of the first optical signal 1000 is influenced by the second radius of curvature R2. The resulting structure with the inward curved top surface for the third transition top surface 1603 may be referred to as a fourth optical device 1700.

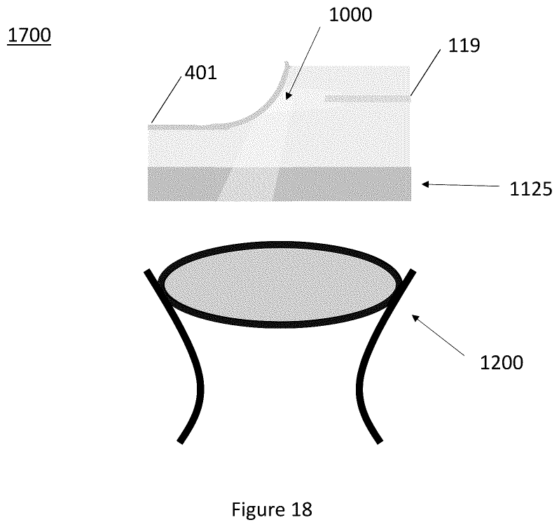

With reference now to FIG. 18, the first optical signal 1000 is depicted as transmitted from the first waveguide structure 119 within the fourth optical device 1700 towards the first reflective structure 401 where it is redirected towards the first active layer 105. In this embodiment, at least a portion of the first optical signal 1000 passes through the first active layer 105 where the first optical signal 1000 is captured by the first optical sensor 1200.

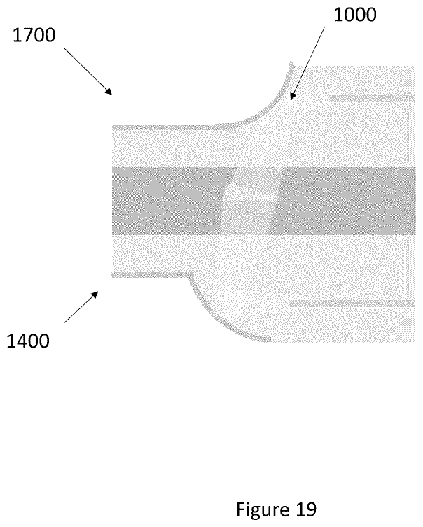

With reference now to FIG. 19, the fourth optical device 1700 is connected to the third optical device 1400 in a similar manner as described above with respect to the first waveguide layer 1175 and the first waveguide substrate 1125 connected to the second waveguide substrate 1150 and the second waveguide layer 1100. This embodiment is merely illustrative and not intended to be limiting. In an embodiment, any of the various optical devices (e.g., the first optical device 950, the second optical device, the third optical device 1400, the fourth optical device 1700, etc.) described above may be bonded in a similar manner to any of the other various optical devices (e.g., the first optical device 950, the second optical device, the third optical device 1400, the fourth optical device 1700, etc.) described above.

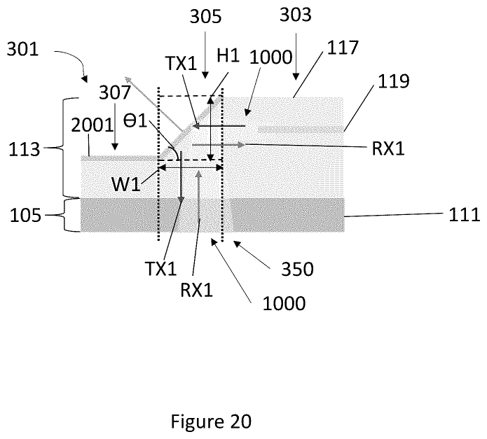

With reference now to FIG. 20, the first optical device 950 is formed in a similar manner and from similar materials as described above with the exception that the first reflective structure 401 is replaced by a first distributed Bragg reflector (DBR) 2001. In this embodiment, the first DBR 2001 may be formed by forming alternating layers of a first refractive index layer (not separately illustrated) and a second refractive index layer (not separately illustrated), the first refractive index layer having a different refractive index than the second refractive index layer.

In an embodiment, the first refractive index layer may comprise a dielectric material, such as silicon nitride, silicon oxide, silicon oxynitride, SiCN, the like, or a combination thereof. In another embodiment, the first refractive index layers may comprise a semiconductor material, such as silicon, such as amorphous silicon (a-Si); germanium; a compound semiconductor, such as silicon carbide, gallium arsenic, gallium phosphide, indium phosphide, indium arsenide, and/or indium antimonide; an alloy semiconductor such as, SiGe, GaAsP, AlInAs, AlGaAs, GaInAs, GaInP, and/or GaInAsP, the like, or combinations thereof. However, any suitable material may be utilized for the first refractive index layers. In an embodiment, the first refractive index layers may be deposited by a suitable deposition process, such as chemical vapor deposition (CVD), physical vapor deposition (PVD), atomic layer deposition (ALD), combinations of these, or the like or may be grown by a suitable epitaxy process. However, any suitable deposition process or formation process may be utilized in forming the first refractive index layers. In an embodiment, the material of the first refractive index layers is selected to have a first refractive index. The first refractive index of the first refractive index layers may be in a range of 1.3 to 3.7.

In an embodiment, the second refractive index layer may comprise a dielectric material, such as silicon nitride, silicon oxide, silicon oxynitride, SiCN, the like, or a combination thereof. In another embodiment, the second refractive index layers may comprise a semiconductor material, such as silicon, such as amorphous silicon (a-Si); germanium; a compound semiconductor, such as silicon carbide, gallium arsenic, gallium phosphide, indium phosphide, indium arsenide, and/or indium antimonide; an alloy semiconductor such as, SiGe, GaAsP, AlInAs, AlGaAs, GaInAs, GaInP, and/or GaInAsP, the like, or combinations thereof. However, any suitable material may be utilized for the second refractive index layers. In an embodiment, the second refractive index layers may be deposited by a suitable deposition process, such as chemical vapor deposition (CVD), physical vapor deposition (PVD), atomic layer deposition (ALD), combinations of these, or the like or may be grown by a suitable epitaxy process. However, any suitable deposition process or formation process may be utilized in forming the second refractive index layers. In an embodiment, the material of the second refractive index layers is selected to have a second refractive index. The second refractive index of the second refractive index layers may be in a range of 1.3 to 3.7.

In an embodiment, the first DBR 2001 operates by reflecting most optical signals (e.g., various wavelengths of optical signals) from the first optical signal 1000, but for optical signals with specific wavelengths at specific angles of incidence a portion of the first optical signal 1000 is permitted to pass through the first DBR 2001. In an embodiment, the portion of the first optical signal 1000 permitted to pass through the first DBR 2001 passes through the first DBR 2001 over the transition top surface 305 at an angle normal to the transition top surface 305. The remaining portion of the first optical signal 1000 is reflected in a similar manner as with respect to the first optical device 950 discussed above.

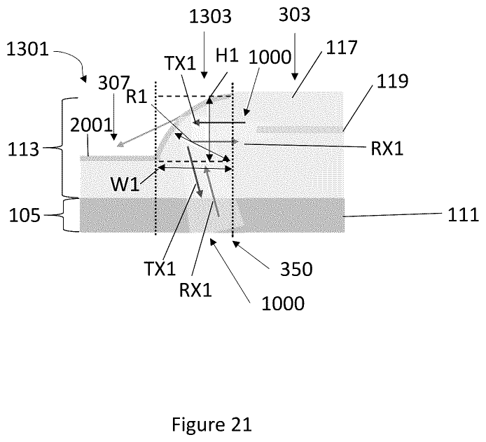

With reference now to FIG. 21, the third optical device 1400 is formed in a similar manner and from similar materials as described above with the exception that the first reflective structure 401 is replaced by the first DBR 2001. In this embodiment, the first DBR 2001 may be formed in a similar manner and from similar materials as discussed above. However, any suitable process and materials may be utilized in forming the first DBR 2001.

In an embodiment, the first DBR 2001 operates by reflecting most optical signals (e.g., various wavelengths of optical signals) from the first optical signal 1000, but for optical signals with specific wavelengths at specific angles of incidence a portion of the first optical signal 1000 is permitted to pass through the first DBR 2001. In an embodiment, the portion of the first optical signal 1000 permitted to pass through the first DBR 2001 passes through the first DBR over the second transition top surface 1303 at an obtuse angle from the second transition top surface 1303. The remaining portion of the first optical signal 1000 is reflected in a similar manner as with respect to the third optical device 1400 discussed above.

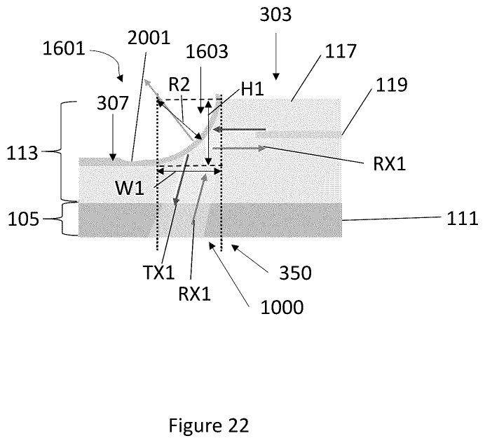

With reference now to FIG. 22, the fourth optical device 1700 is formed in a similar manner and from similar materials as described above with the exception that the first reflective structure 401 is replaced by the first DBR 2001. In this embodiment, the first DBR 2001 may be formed in a similar manner and from similar materials as discussed above. However, any suitable process and materials may be utilized in forming the first DBR 2001.

In an embodiment, the first DBR 2001 operates by reflecting most optical signals (e.g., various wavelengths of optical signals) from the first optical signal 1000, but for optical signals with specific wavelengths at specific angles of incidence a portion of the first optical signal 1000 is permitted to pass through the first DBR 2001. In an embodiment, the portion of the first optical signal 1000 permitted to pass through the first DBR 2001 passes through the first DBR over the third transition top surface 1603 at an angle normal to the tangent of the inward curve from the third transition top surface 1603. The remaining portion of the first optical signal 1000 is reflected in a similar manner as with respect to the fourth optical device 1700 discussed above.

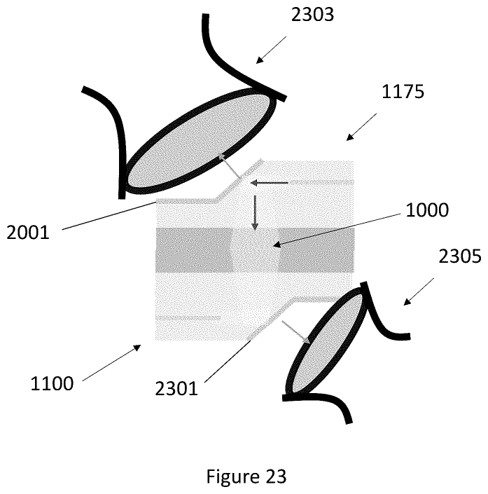

With reference now to FIG. 23, an embodiment is depicted in which the first waveguide layer 1175 is connected to the second waveguide layer 1100 in a similar manner as described above with the exception that the first reflective structure 401 is replaced with the first DBR 2001 in a similar manner as discussed above and the third reflective structure 1101 is replaced with a second DBR 2301 in a similar manner as the first reflective structure 401 is replaced with the first DBR 2001 as discussed above. In this embodiment, a second optical sensor 2303 may be positioned adjacent to the first DBR 2001 to capture the portion of the first optical signal 1000 permitted to pass through the first DBR 2001. In an embodiment, the second optical sensor 2303 may be a CMOS sensor. Further, in this embodiment, a third optical sensor 2305 may be positioned adjacent to the second DBR 2301 to capture a portion of the reflected first optical signal 1000 by the first DBR 2001 that is permitted to pass through the second DBR 2301. In an embodiment, the third optical sensor 2305 may be a CMOS sensor.

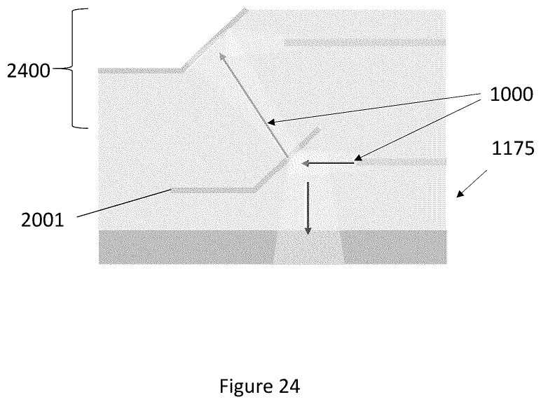

With reference now to FIG. 24, the first waveguide layer 1175 is depicted with the first DBR 2001 where a portion of the first optical signal 1000 is permitted to pass through the first DBR 2001 into a second optical interconnect structure 2400 formed over the first waveguide layer 1175. In this embodiment, the first waveguide layer 1175 is formed in a similar manner and from similar materials as discussed above. In an embodiment, the second optical interconnect structure 2400 is formed over the first waveguide layer 1175 in a similar manner and from similar materials as the optical interconnect structure 900.

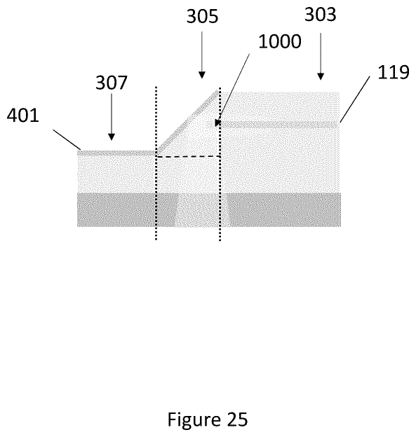

With reference now to FIG. 25, the first detail view 150 is depicted and formed in a similar manner as discussed above with the exception that a portion of the first waveguide structure 119 is positioned directly underneath the transition top surface 305. In this embodiment, the first optical signal 1000 has a relatively smaller beam size at the transition top surface 305 (as opposed to the first waveguide structure 119 being positioned completely underneath the first top surface 303) and the first optical signal 1000 has a stronger light intensity, and smaller region (region where light is incident) on the transition top surface 305.

While the first detail view 150 is illustrated in FIG. 25, this is merely illustrative and any of the optical devices (e.g., the first optical device 950, the second optical device, the third optical device 1400, and the fourth optical device 1700) are intended to be included within this embodiment.

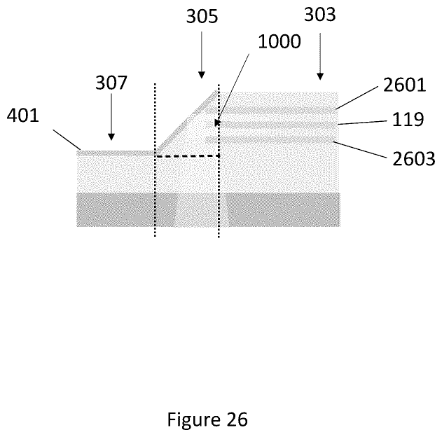

With reference now to FIG. 26, in addition to the first waveguide structure 119 depicted in the first detail view 150, a third waveguide structure 2601 and a fourth waveguide structure 2603 is formed within the alternating first dielectric layers 117. In this embodiment, the first waveguide structure 119 transmits the first optical signal 1000, and the third waveguide structure 2601 and the fourth waveguide structure 2603 are able to transmit additional optical signals. While three waveguide structures are illustrated as embedded in the alternating first dielectric layers 117, this is merely illustrative and any number of waveguide structures may be utilized. Additionally, the additional waveguide structures may be utilized in any of the embodiments and various optical devices described above.

Benefits of the embodiments presented in the present disclosure include, but are not limited to, the ability to direct the first optical signal 1000 within various optical devices (e.g., the first optical device 950, the second optical device, the third optical device 1400, and the fourth optical device 1700) to either other optical devices (e.g., the first optical device 950, the second optical device, the third optical device 1400, and the fourth optical device 1700) or to various optical sensors (e.g., the first optical sensor 1200, etc.). Additional benefits include controlling the angle that the first optical signal 1000 may be directed at (e.g., the first angle θ1) as well as splitting the first optical signal 1000 to various optical devices or sensors while controlling the angle (e.g., acute angles, obtuse angles, etc.) the first optical signal 1000 is reflected at within the optical devices.

In accordance with an embodiment, a method includes forming a first waveguide layer over a first substrate, wherein the forming the first waveguide layer includes embedding a first waveguide component in an insulating layer, etching a top surface of the first waveguide layer, wherein the etching the top surface of the first waveguide layer forms a first portion of the top surface below a second portion of the top surface, and a transition portion of the top surface interposed between the first portion and the second portion, and forming a first reflective structure over the first portion of the top surface and over the transition portion of the top surface, wherein the first reflective structure is conformal with the first portion and the transition portion. In an embodiment, wherein the etching the top surface of the first waveguide layer forms the transition portion as a curved shape. In an embodiment, further including embedding a second waveguide component in the insulating layer interposed directly between the first waveguide component and the first substrate, wherein the first waveguide component and the second waveguide component are adjacent to the first reflective structure, and embedding a third waveguide component in the insulating layer interposed directly between the first waveguide component and the top surface of the first waveguide layer, wherein the third waveguide component is adjacent to the first reflective structure. In an embodiment, wherein the forming the first reflective structure forms the transition portion directly over the first waveguide component. In an embodiment, wherein the first reflective structure is a distributed Bragg reflector. In an embodiment, wherein the forming the first reflective structure includes depositing a metal. In an embodiment, wherein the first substrate includes a semiconductor device.

In accordance with an embodiment, a device includes a first substrate, the first substrate including an optical device layer, and a semiconductor die, a first waveguide structure over the first substrate, the first waveguide structure including a first optical component surrounded by cladding material, wherein the first waveguide structure has a top surface, the top surface including a first portion at a first distance from the first substrate, a second portion at a second distance from the first substrate, and a transition portion between the first portion to the second portion, wherein the second distance is greater than the first distance, and a first reflective structure over the first portion and the transition portion, wherein a portion of the first reflective structure over the transition portion is a curved surface. In an embodiment, further including a sensor positioned adjacent to the first substrate. In an embodiment, wherein the first reflective structure includes a distributed Bragg reflector. In an embodiment, further including a second waveguide structure over the first waveguide structure opposite the first substrate, and a second reflective surface embedded in the second waveguide structure. In an embodiment, further including, a second substrate bonded to the first substrate opposite the first waveguide structure, a second waveguide structure on the second substrate opposite the first substrate, and a second reflective structure over a recessed portion of a bottom surface of the second waveguide structure, wherein the second reflective structure has a conformal shape with the recessed portion of the bottom surface. In an embodiment, wherein the curved surface has a constant radius. In an embodiment, wherein the curved surface curves outward away from the first substrate.

In accordance with an embodiment, a method includes depositing a first plurality of dielectric layers over a first substrate, wherein during the depositing the first plurality of dielectric layers a first waveguide component is formed within the first plurality of dielectric layers, etching a first recess through a portion of the first plurality of dielectric layers, wherein the first recess extends past the first waveguide component, conformally depositing a first reflective structure over the first recess and over a top surface of the first plurality of dielectric layers, and removing portions of the first reflective structure that are over the top surface of the first plurality of dielectric layers. In an embodiment, further including depositing a dielectric material over the first reflective structure within the first recess, and forming a second plurality of dielectric layers over the top surface of the first plurality of dielectric layers, wherein a top surface of the second plurality of dielectric layers comprises a second reflective structure. In an embodiment, wherein the first reflective structure is a distributed Bragg reflector. In an embodiment, wherein a portion of the first reflective structure has a constant radial curvature. In an embodiment, wherein the first substrate includes bulk silicon. In an embodiment, wherein the first substrate includes a semiconductor device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device comprising:
a first active layer;
a first metallization structure on a first side of the first active layer, wherein the first metallization structure includes:
a plurality of dielectric layers; and
an optical waveguide in the plurality of dielectric layers;
an interface layer over the first metallization structure, wherein the interface layer extends into a recess in the first metallization structure; and
a reflective layer along a sidewall of the recess, the reflective layer being between the interface layer and the plurality of dielectric layers, wherein the reflective layer is optically aligned with the optical waveguide.

2. The device of claim 1, wherein the reflective layer comprises a metal.

3. The device of claim 1, wherein the reflective layer comprises a distributed Bragg reflector.

4. The device of claim 1, wherein the sidewall of the recess has a curved profile.

5. The device of claim 4, wherein the curved profile has an outward curvature.

6. The device of claim 4, wherein the curved profile has an inward curvature.

7. The device of claim 1, wherein light of a first wavelength from the optical waveguide is reflected by the reflective layer, wherein light of a second wavelength from the optical waveguide passes through the reflective layer.

8. A device comprising:
a first optical structure comprising a first substrate with a first waveguide component and a first reflective structure; and
a second optical structure bonded to the first optical structure, the second optical structure comprising a second substrate with a second waveguide component and a second reflective structure, wherein the first reflective structure is configured to redirect an optical signal from the first waveguide component toward the second reflective structure, and wherein the second reflective structure is configured to redirect the optical signal toward the second waveguide component.

9. The device of claim 8, wherein the first reflective structure is curved.

10. The device of claim 8, wherein the first reflective structure is a distributed Bragg reflector.

11. The device of claim 8, further comprising a through via extending through the first substrate.

12. The device of claim 11, further comprising a dielectric layer on the first optical structure, wherein the first reflective structure is between the dielectric layer and the first substrate.

13. The device of claim 12, wherein the dielectric layer extends into the first substrate, further comprising a bond pad in the dielectric layer, wherein the bond pad contacts the through via.

14. An optical device comprising:
a device layer;
an optical interconnect structure on a first side of the device layer, wherein the optical interconnect structure comprises:
a plurality of first dielectric layers;
a first reflective structure on a sidewall of one or more of the plurality of first dielectric layers; and
a first waveguide in the plurality of first dielectric layers; and
an interconnect structure on a second side of the device layer, wherein the interconnect structure comprises:
a plurality of second dielectric layers;
a second reflective structure on a sidewall of one or more of the plurality of second dielectric layers; and
a second waveguide in the plurality of second dielectric layers.

15. The optical device of claim 14, further comprising a through via extending through the optical interconnect structure.

16. The optical device of claim 15, further comprising an interface layer over the optical interconnect structure, wherein the optical interconnect structure is between the interface layer and the device layer.

17. The optical device of claim 16, wherein the interface layer extends into a recess in the plurality of first dielectric layers.

18. The optical device of claim 16, wherein the interface layer comprises a bond pad coupled to the through via.

19. The optical device of claim 14, wherein the first reflective structure and the second reflective structure are curved.

20. The optical device of claim 14, wherein at least one of the first reflective structure and the second reflective structure is a distributed Bragg reflector.
